(19) United States
(12) Patent Application Publication
(10) Pub. No.: US 2024/0331004 A1
(43) Pub. Date: Oct. 3, 2024

(54) AUTOMATICALLY GENERATED PRODUCT RECOMMENDATIONS BASED UPON QUESTIONS AND ANSWERS

(71) Applicant: Amazon Technologies, Inc., Seattle, WA (US)

(72) Inventors: Eilon Shitrit, Haifa (IL); Soomin Lee, Mountain View, CA (US); Avihai Mejer, Atlit (IL)

(73) Assignee: Amazon Technologies, Inc., Seattle, WA (US)

(21) Appl. No.: 18/128,353

(22) Filed: Mar. 30, 2023

(51) Int. Cl. G06Q 30/0601

(52) U.S. Cl. CPC G06Q 30/0631; G06Q 30/0625

(57) ABSTRACT

An automatic technique is disclosed to enrich presented answers by highlighting relevant shopping recommendations. The shopping recommendations can either be highlighted within the answer itself, or as an auxiliary list of suggestions. A model is described for selecting phrases from the answer text (sequences of consecutive terms called noun phrases) that refer to potential products that likely represent relevant shopping recommendation in context of the question-answer pair. The noun phrases are then ranked in order of importance. The top-ranked noun phrases are used to search products to be displayed in association with the noun phrases. Clicking or tapping on a highlighted noun phrase launches a shopping-related flow, such as presenting a widget with product recommendations or running a search in a search engine.

### BACKGROUND

Question Answering (QA) is a popular feature in e-commerce services that many customers use as part of a shopping journey. QA relates to building systems that automatically answer questions posted by users in a natural language. Part of QA is natural language processing, which includes processing text, understanding the meaning of particular words, understanding a discourse context for the words, and drawing inferences from the passages and the contents. Once the natural language processing is complete, an answer can be provided that may be helpful to a user in generating a new search for particular products. For example, a user can generate a question, such as “how to remove dog hair from furniture?” and an automated answer can be provided, such as “try a lint brush or a squeegee with a rubber edge”. The user can then use the answer to generate a proper search in a search box. Although the QA experience is useful, it can be improved through further automation.

### BRIEF DESCRIPTION OF THE DRAWINGS

FIG. 1 is a diagram of a User Interface (UI) wherein a noun phrase is highlighted and associated with products using a linking arrow.

FIG. 2 is a diagram of a UI with a noun phrase in an answer associated with a product and an n-gram associated with a review of the product.

FIG. 3 is a system diagram showing the UI interacting with a backend system that includes a semantic similarity model.

FIG. 4 shows further details of the semantic similarity model of FIG. 3.

FIG. 5 provides a particular example of the semantic similarity model of FIG. 4.

FIG. 6 shows obtaining click data for training the semantic similarity model of FIGS. 3 and 4.

FIG. 7 is an example system diagram showing a plurality of virtual machine instances running in the multi-tenant environment with the semantic similarity model executing on a server computer.

FIG. 8 is a flowchart according to one embodiment for generating a display having products associated with n-grams.

FIG. 9 is a flowchart according to another embodiment for generating a display having products associated with n-grams.

FIG. 10 depicts a generalized example of a suitable computing environment in which the described innovations may be implemented.

### DETAILED DESCRIPTION

In QA, the answers can incite a customer's curiosity and open opportunities for shopping actions. However, the current solutions do not provide the customers with an easy and natural bridge from asking questions to shopping activities. An automatic technique is disclosed to enrich presented answers by highlighting relevant shopping recommendations. The shopping recommendations can either be highlighted within the answer itself, or as an auxiliary list of suggestions. A model is described for selecting phrases from the answer text (sequences of words called n-grams) that refer to potential products that likely represent relevant shopping recommendations in context of the question-answer pair. From the n-grams, noun phrases can be extracted. Noun phrases are a type of n-gram that include a noun. The noun phrases are then ranked in order of scores. The highest scoring noun phrases are used to search products to be displayed in association with the noun phrases. Clicking (in the web interface) or tapping (in a mobile device) on a highlighted noun phrase launches a shopping-related flow, such as presenting a widget with product recommendations or running a search in a search engine.

Although embodiments described herein are focused on noun phrases, such embodiments can apply equally to any type of n-grams.

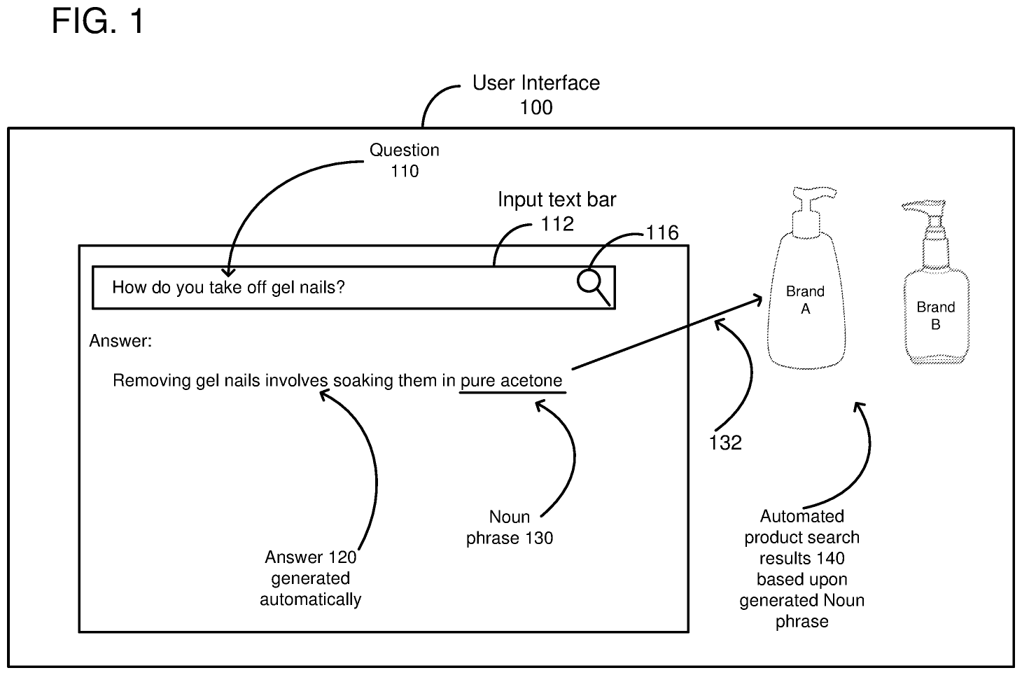

FIG. 1 is a UI 100 used for e-commerce. A user can type a question 110 into an input text bar 112 and select a search indicator 116. Although shown as a question, the input text bar can also receive a search query or voice recognition commands. An answer 120 is displayed that is associated with the question. The answer 120 can have certain noun phrases, such as noun phrase 130 highlighted through underlining, changing color, changing formatting, etc. The user has an option of selecting the noun phrase, such as through clicking, hovering, etc. The highlighted noun phrase 130 has an arrow 132 pointed at product search results 140 to create an association between the noun phrase 130 and the product search results 140. Although an association is shown using an arrow, other associations can be used, such as by using color, text or other formatting. The product search results 140 can either be displayed automatically or after the user selects the noun phrase. Although only a single noun phrase is displayed, the answer can have a plurality of noun phrases and a product search can be performed after the user selects the particular noun phrase of interest. One advantage of the UI 100 is that the user need not reformulate a search query but can instead just select the appropriate noun phrase to continue searching for a desired product. Additionally, the user can ask a question without necessarily thinking about products, but the answer provides helpful product recommendations that initiate a shopping journey for the user. In some cases, content other than products can be associated with noun phrases, such as instructional videos, photos, reviews, etc.

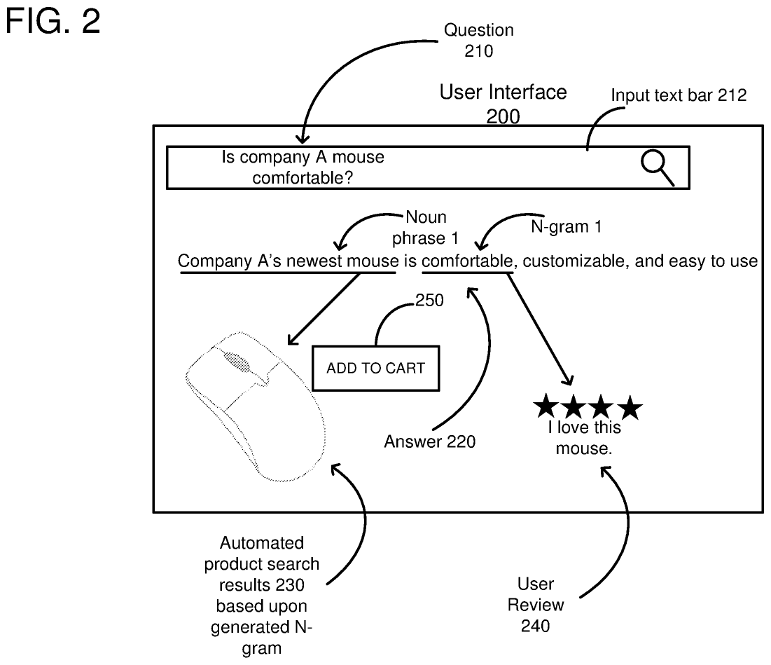

FIG. 2 shows another example of a UI 200 wherein a question 210 is entered into an input text bar 212. An answer 220 is generated automatically and two n-grams are indicated including noun phrase 1 and n-gram 1 through highlighting. The noun phrase 1 includes multiple words including “Company A's newest mouse”, while n-gram 1 includes only a single word (adjective) including the word “comfortable”. The UI 200 can associate some n-grams with products and other with content, such as reviews. For example, noun phrase 1 has been identified as including a product-related term and a search for the product produces search results 230. However, n-gram 1 has been identified as an adjective, which results in a user review 240 being displayed. Thus, multiple n-grams can be within a single answer and the n-grams can be associated with different types of supplementary information, such as products, reviews, explanatory videos, etc. Additionally, like in FIG. 1, an association can be created between the n-grams and the supplementary information, such as an arrow indicating that the two are paired together or otherwise associated together. Once a product is found, such as is shown at 230, an add-to-cart button 250 can be displayed to allow the user to easily purchase the product.

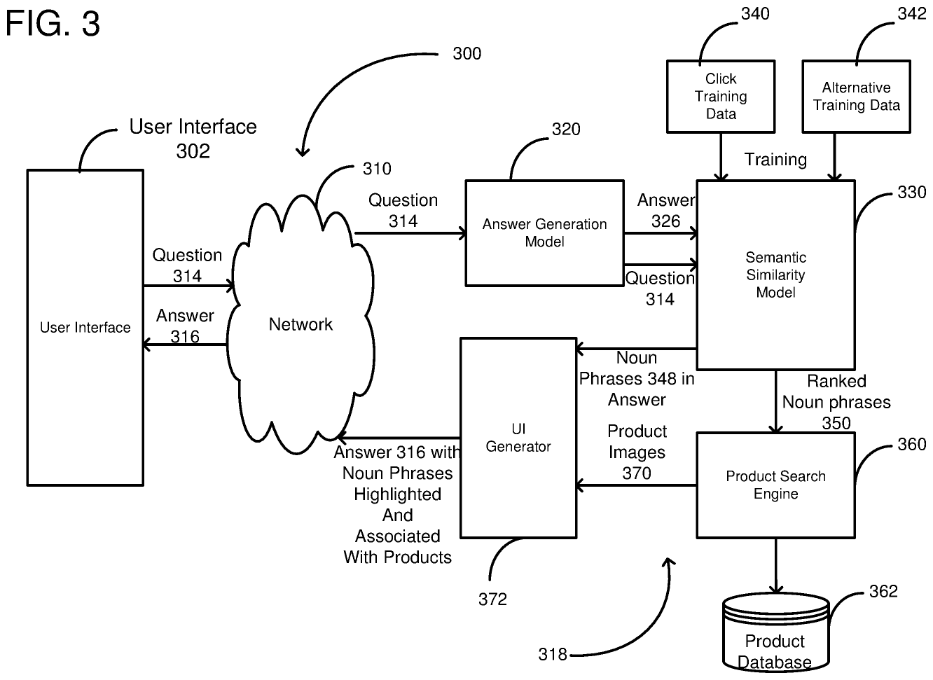

FIG. 3 is a system 300 for generating the UI of FIGS. 1 and 2. The UI 302 is typically on a client computer (not shown) coupled to a network 310, such as the Internet. One or more backend server computers 318 are used for receiving a question 314 from the UI 302 and for providing an answer 316 with noun phrases highlighted and associated products displayed as results, as shown in FIG. 1. The question 314 can be user-generated or system-generated combined with a user selection of the question. In either case, the question 314 is received from the UI 302 in a server computer executing an answer generation model 320. The answer generation model 320 can process text, understanding the meaning of particular words, understanding a discourse context for the words, and drawing inferences from the passages and the contents. The answer generation model 320 can then generate an answer 326 to the question 314. The answer generation model 320 can also select saved questions that were received from a third-party. However, before the answer 326 is supplied back to the UI 302, it is further enhanced with supplemental data. For example, the answer 326 is transmitted to a server computer executing a semantic similarity model 330. In an offline mode, the semantic similarity model 330 can be trained using click training data 340. As further described below, the click training data can relate to searches (by third parties) for products and different search terms used that resulted in a finding of a same product. It is assumed that because the same product was found, the search terms in the different searches are related. Thus, the click training data 340 is automatically generated using click data from multiple users of an e-commerce website. Further alternative training data 342 can have manually chosen training data to supplement the click training data 340. After being trained, the semantic similarity model 330 can parse the answer 326 and search for noun phrases 348 within the answer. Using techniques described below, the noun phrases can then be ranked to provide ranked noun phrases 350. The ranked noun phrases 350 can be supplied to a product search engine 360 that can use the noun phrases to find related products in a products database 362, which includes image data for the products. The product search engine 360 provides the product images 370 to a UI generator 372. The noun phrases 348 are also supplied to the UI generator 372, either from the semantic similarity model 330 or the product search engine 360. In either case, the UI generator 372 receives an association (or linking) describing which noun phrases are linked to which product images 370. The UI generator 372 can then provide the answer 316 with the noun phrases highlighted and linked to the corresponding products. The answer 316 passes back through the network 310 and is displayed in the user interface 302. Although described as a question/answer, the UI 302 can receive search queries by text or voice commands. Additionally, although FIG. 3 is described in relation to noun phrases, it can be extended to other types of n-grams. Typically, the noun phrases (which are a type of n-gram) are identified from the n-grams and used for determining products.

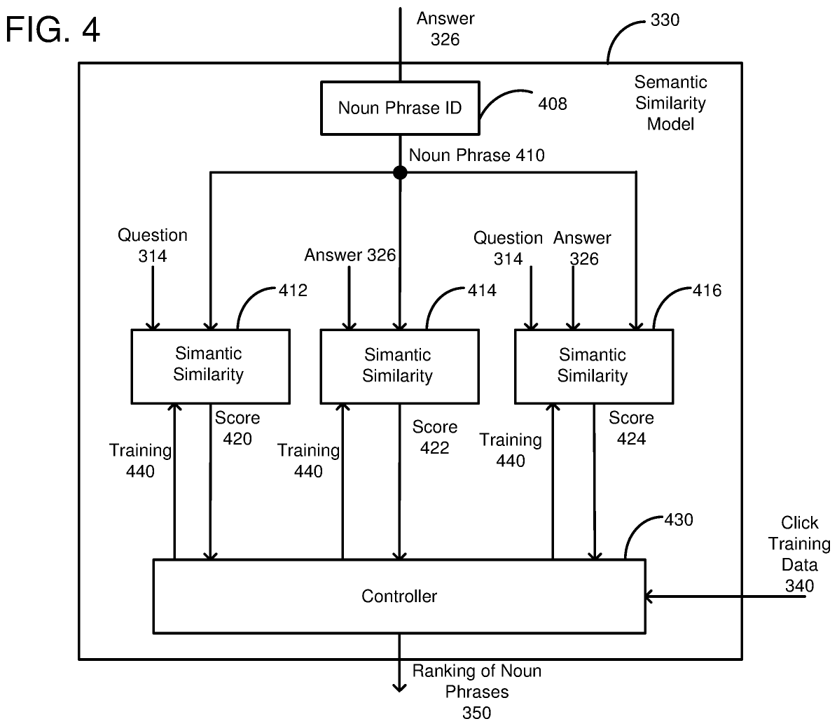

FIG. 4 shows the semantic similarity model 330 in more detail. The answer 326 is input into a noun phrase identifier 408 that parses the answer and extracts noun phrases. The noun phrase identifier 408 can be a Natural Language Processing (NLP) modelling tool. The NLP modelling tool can include a multi-layer perceptron (MLP) classifier, which includes an underlying Neural Network to classify portions of the answer, and a semantic segmentation algorithm to identify noun phrases and dependency relations in noun-phrase words. The output of the noun phrase identifier 408 is a plurality of noun phrases 410 included in the answer 326. The semantic similarity model 330 also includes a plurality of semantic similarity modules 412, 414, and 416 that generate scores based upon combinations of inputs including the following: one of the noun phrases 410 and a question (input into module 412); one of the noun phrases 410 and an answer (input into module 414); and one of the noun phrases 410 with a question and answer (input into module 416). Instead of multiple semantic similarity modules 412, 414 and 416 in parallel, a single semantic similarity model can be used to perform a serial operation. Each of the semantic similarity modules 412, 414 and 416 produce one or more scores 420, 422, and 424 based upon the combinations. As described further below, the semantic similarity module 416 computes 2 scores based on different combinations of the question, answer and noun phrase. Additional scores or less scores can be computed based upon the design. A controller 430 receives the scores and ranks the noun phrases based upon the scores to produce the output 350. Click training data 340 can be received by the controller and used to train 440 the semantic similarity modules 412, 414, and 416 as feedback from past results. The training data 440 can result in adjusting weighting within the semantic similarity modules 412, 414, and 416. The training data 440 can be obtained offline using several pre-trained sentence Bidirectional Encoder Representations from Transformers (BERT) models to represent the candidate keywords, questions, and answers using vectors.

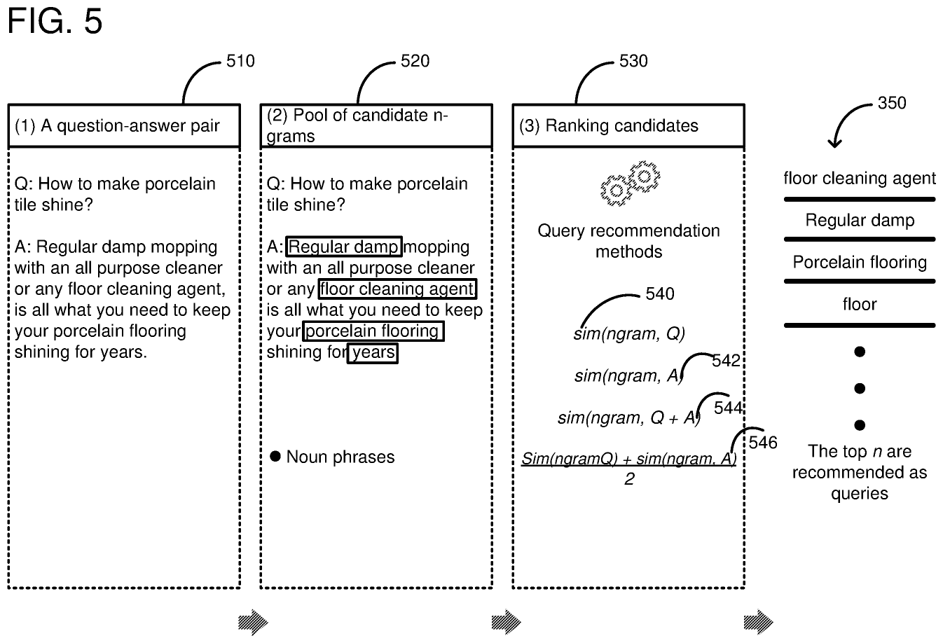

FIG. 5 is an example of how the semantic similarity model 330 can convert a question-answer pair 510 into a ranked output 350. First, the semantic similarity model 330 receives both the question 314 and answer 326 (shown as the question-answer pair 510) from the answer generation module 320 (FIG. 3). At 520, a plurality of noun phrases are identified using the noun phrase identifier 408. The noun phrases are highlighted by placing a box around the noun phrase as can be seen, for example, with the words “Regular damp”. Other noun phrases are also identified including “floor cleaning agent”, “porcelain flooring” and “years”. At 530, scores are generated using four combinations of inputs into the semantic similarity modules. A first combination of inputs, at 540, includes the noun phrase and the question. A second combination of inputs, at 542, includes the noun phrase and the answer. A third combination of inputs, at 544, includes the noun phrase with a combination of the question and answer. A fourth combination, at 546, also includes the noun phrase with a combination of the question and answer separately computed and then averaged. These combinations can be repeated for each noun phrase identified at 520. The different combinations described above can be summarized generically using a following formula: SimScore=Sim(ngram,Q)*z+Sim(ngram, A)*(1−z), wherein z is a hyper-parameter that is chosen between 0 and 1. Thus, z is a weighting parameter defining the relative weight of the question or answer as inputs into the semantic similarity module. The controller 430 accumulates all of the scores as outputs of the semantic similarity modules and based upon the scores, produces the ranking 350. As described below, the ranking 350 can be used to identify products, which can then be displayed in the UI 100 (FIG. 1), as shown at 140.

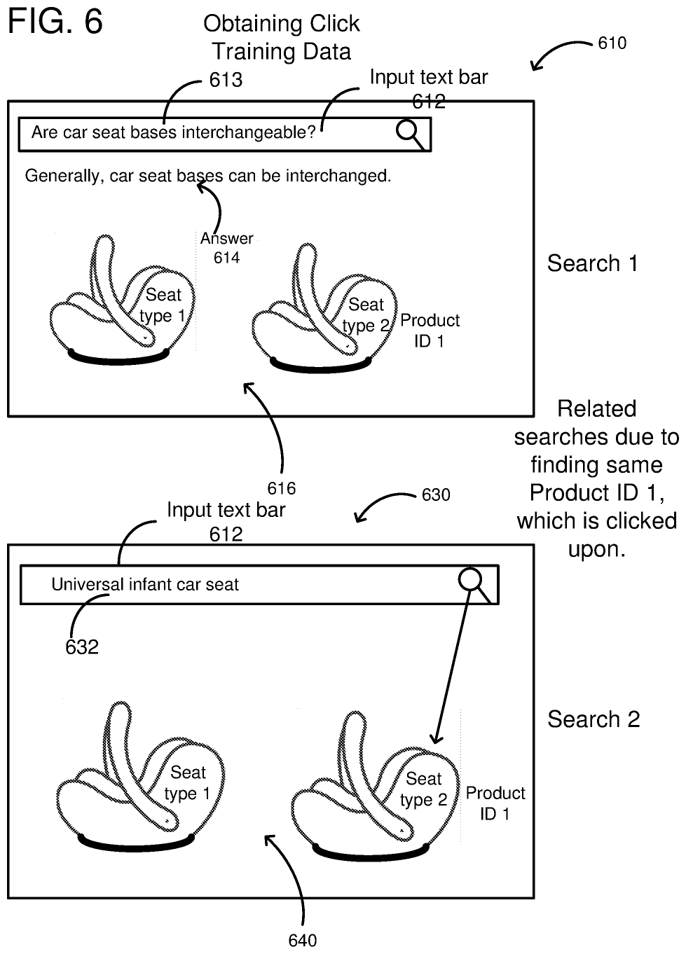

FIG. 6 is an example of acquiring training data through click data. In particular, different searches from different customers can be determined to be related through similar results. Accordingly, the noun phrases within the input terms are also related. The related input terms can then be used as training data 340. In a first search 610, a first user types into a input text bar 612, a question 613: “Are car seat bases interchangeable?” An answer 614 is shown, and products 616 are displayed. Of particular interest to the example is Product ID 1 being identified due to the search. The user can click on (or otherwise select) Product ID 1 as an affirmation that the product is correctly linked to the phrase 613 searched upon. In a second search 630, performed by the same customer or a different customer, a search query is used that is not a question, but rather includes standard search terms 632. Notably, an answer is not provided, but the results of the search are shown at 640. The same Product ID 1 is found by the search. If the customer clicks on that product, then the search terms 632 are linked to the product. Additionally, the search terms 632 (and any noun phrases therein), the question 613 (and any noun phrases therein), and the Product ID 1 are all associated together. This association can then be used as the click training data 340.

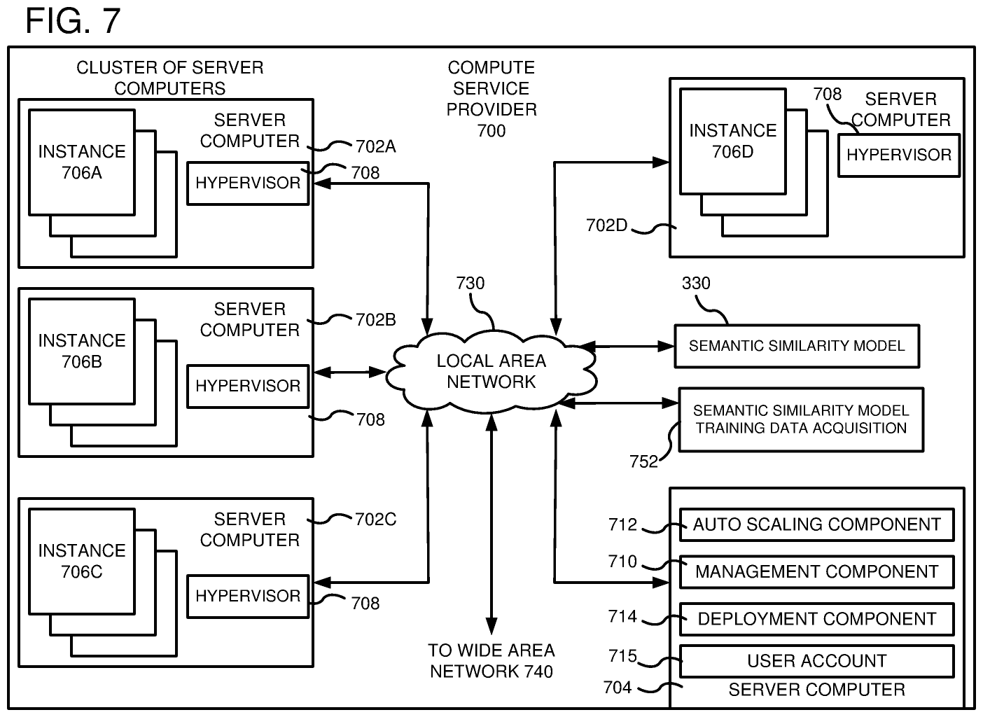

FIG. 7 is a computing system diagram of a network-based compute service provider 700 that illustrates one environment in which embodiments described herein can be used. By way of background, the compute service provider 700 (i.e., the cloud provider) is capable of delivery of computing and storage capacity as a service to a community of end recipients. In an example embodiment, the compute service provider can be established for an organization by or on behalf of the organization. That is, the compute service provider 700 may offer a “private cloud environment.” In another embodiment, the compute service provider 700 supports a multi-tenant environment, wherein a plurality of customers operate independently (i.e., a public cloud environment). Generally speaking, the compute service provider 700 can provide the following models: Infrastructure as a Service (“IaaS”), Platform as a Service (“PaaS”), and/or Software as a Service (“SaaS”). Other models can be provided. For the IaaS model, the compute service provider 700 can offer computers as physical or virtual machines and other resources. The virtual machines can be run as guests by a hypervisor, as described further below. The PaaS model delivers a computing platform that can include an operating system, programming language execution environment, database, and web server. Application developers can develop and run their software solutions on the compute service provider platform without the cost of buying and managing the underlying hardware and software. The SaaS model allows installation and operation of application software in the compute service provider. In some embodiments, end customers access the compute service provider 700 using networked client devices, such as desktop computers, laptops, tablets, smartphones, etc. running web browsers or other lightweight client applications. Those skilled in the art will recognize that the compute service provider 700 can be described as a “cloud” environment.

In some implementations of the disclosed technology, the computer service provider 500 can be a cloud provider network. A cloud provider network (sometimes referred to simply as a “cloud”) refers to a pool of network-accessible computing resources (such as compute, storage, and networking resources, applications, and services), which may be virtualized or bare-metal. The cloud can provide convenient, on-demand network access to a shared pool of configurable computing resources that can be programmatically provisioned and released in response to customer commands. These resources can be dynamically provisioned and reconfigured to adjust to variable load. Cloud computing can thus be considered as both the applications delivered as services over a publicly accessible network (e.g., the Internet, a cellular communication network) and the hardware and software in cloud provider data centers that provide those services.

With cloud computing, instead of buying, owning, and maintaining their own data centers and servers, organizations can acquire technology such as compute power, storage, databases, and other services on an as-needed basis. The cloud provider network can provide on-demand, scalable computing platforms to customers through a network, for example allowing customers to have at their disposal scalable “virtual computing devices” via their use of the compute servers and block store servers. These virtual computing devices have attributes of a personal computing device including hardware (various types of processors, local memory, random access memory (“RAM”), hard-disk and/or solid-state drive (“SSD”) storage), a choice of operating systems, networking capabilities, and pre-loaded application software. Each virtual computing device may also virtualize its console input and output (“I/O”) (e.g., keyboard, display, and mouse). This virtualization allows customers to connect to their virtual computing device using a computer application such as a browser, application programming interface, software development kit, or the like, in order to configure and use their virtual computing device just as they would a personal computing device. Unlike personal computing devices, which possess a fixed quantity of hardware resources available to the customer, the hardware associated with the virtual computing devices can be scaled up or down depending upon the resources the customer requires. Customers can choose to deploy their virtual computing systems to provide network-based services for their own use and/or for use by their customers or clients.

A cloud provider network can be formed as a number of regions, where a region is a separate geographical area in which the cloud provider clusters data centers. Each region can include two or more availability zones connected to one another via a private high-speed network, for example a fiber communication connection. An availability zone (also known as an availability domain, or simply a “zone”) refers to an isolated failure domain including one or more data center facilities with separate power, separate networking, and separate cooling from those in another availability zone. A data center refers to a physical building or enclosure that houses and provides power and cooling to servers of the cloud provider network. Preferably, availability zones within a region are positioned far enough away from one other that the same natural disaster should not take more than one availability zone offline at the same time. Customers can connect to availability zones of the cloud provider network via a publicly accessible network (e.g., the Internet, a cellular communication network) by way of a transit center (TC). TCs are the primary backbone locations linking customers to the cloud provider network, and may be collocated at other network provider facilities (e.g., Internet service providers, telecommunications providers) and securely connected (e.g. via a VPN or direct connection) to the availability zones. Each region can operate two or more TCs for redundancy. Regions are connected to a global network which includes private networking infrastructure (e.g., fiber connections controlled by the cloud provider) connecting each region to at least one other region. The cloud provider network may deliver content from points of presence outside of, but networked with, these regions by way of edge locations and regional edge cache servers. This compartmentalization and geographic distribution of computing hardware enables the cloud provider network to provide low-latency resource access to customers on a global scale with a high degree of fault tolerance and stability.

The cloud provider network may implement various computing resources or services that implement the disclosed techniques for TLS session management, which may include an elastic compute cloud service (referred to in various implementations as an elastic compute service, a virtual machines service, a computing cloud service, a compute engine, or a cloud compute service), data processing service(s) (e.g., map reduce, data flow, and/or other large scale data processing techniques), data storage services (e.g., object storage services, block-based storage services, or data warehouse storage services) and/or any other type of network based services (which may include various other types of storage, processing, analysis, communication, event handling, visualization, and security services not illustrated). The resources required to support the operations of such services (e.g., compute and storage resources) may be provisioned in an account associated with the cloud provider, in contrast to resources requested by customers of the cloud provider network, which may be provisioned in customer accounts.

The particular illustrated compute service provider 700 includes a plurality of server computers 702A-702D. While only four server computers are shown, any number can be used, and large centers can include thousands of server computers. The server computers 702A-702D can provide computing resources for executing software instances 706A-706D. In one embodiment, the instances 706A-706D are virtual machines. As known in the art, a virtual machine is an instance of a software implementation of a machine (i.e., a computer) that executes applications like a physical machine. In the example of virtual machine, each of the servers 702A-702D can be configured to execute a hypervisor 708 or another type of program configured to enable the execution of multiple instances 706 on a single server. Additionally, each of the instances 706 can be configured to execute one or more applications.

It should be appreciated that although the embodiments disclosed herein are described primarily in the context of virtual machines, other types of instances can be utilized with the concepts and technologies disclosed herein. For instance, the technologies disclosed herein can be utilized with storage resources, data communications resources, and with other types of computing resources. The embodiments disclosed herein might also execute all or a portion of an application directly on a computer system without utilizing virtual machine instances.

One or more server computers 704 can be reserved for executing software components for managing the operation of the server computers 702 and the instances 706. For example, the server computer 704 can execute a management component 710. A customer can access the management component 710 to configure various aspects of the operation of the instances 706 purchased by the customer. For example, the customer can purchase, rent or lease instances and make changes to the configuration of the instances. The customer can also specify settings regarding how the purchased instances are to be scaled in response to demand. The management component can further include a policy document to implement customer policies. An auto scaling component 712 can scale the instances 706 based upon rules defined by the customer. In one embodiment, the auto scaling component 712 allows a customer to specify scale-up rules for use in determining when new instances should be instantiated and scale-down rules for use in determining when existing instances should be terminated. The auto scaling component 712 can consist of a number of subcomponents executing on different server computers 702 or other computing devices. The auto scaling component 712 can monitor available computing resources over an internal management network and modify resources available based on need.

A deployment component 714 can be used to assist customers in the deployment of new instances 706 of computing resources. The deployment component can have access to account information associated with the instances, such as who is the owner of the account, credit card information, country of the owner, etc. The deployment component 714 can receive a configuration from a customer that includes data describing how new instances 706 should be configured. For example, the configuration can specify one or more applications to be installed in new instances 706, provide scripts and/or other types of code to be executed for configuring new instances 706, provide cache logic specifying how an application cache should be prepared, and other types of information. The deployment component 714 can utilize the customer-provided configuration and cache logic to configure, prime, and launch new instances 706. The configuration, cache logic, and other information may be specified by a customer using the management component 710 or by providing this information directly to the deployment component 714. The instance manager can be considered part of the deployment component.

Customer account information 715 can include any desired information associated with a customer of the multi-tenant environment. For example, the customer account information can include a unique identifier for a customer, a customer address, billing information, licensing information, customization parameters for launching instances, scheduling information, auto-scaling parameters, previous IP addresses used to access the account, etc.

A network 730 can be utilized to interconnect the server computers 702A-702D and the server computer 704. The network 730 can be a local area network (LAN) and can be connected to a Wide Area Network (WAN) 740 so that end customers can access the compute service provider 700. It should be appreciated that the network topology illustrated in FIG. 7 has been simplified and that many more networks and networking devices can be utilized to interconnect the various computing systems disclosed herein.

The semantic similarity model 330 can execute on a server computer within the compute service provider 700. Additionally, a separate server computer 752 can execute the data acquisition needed for training the semantic similarity model 330 and obtaining the click training data 340. As described above, the training data can be obtained by reviewing search terms, noun phrases used in questions and any other queries that result in finding a same or similar products.

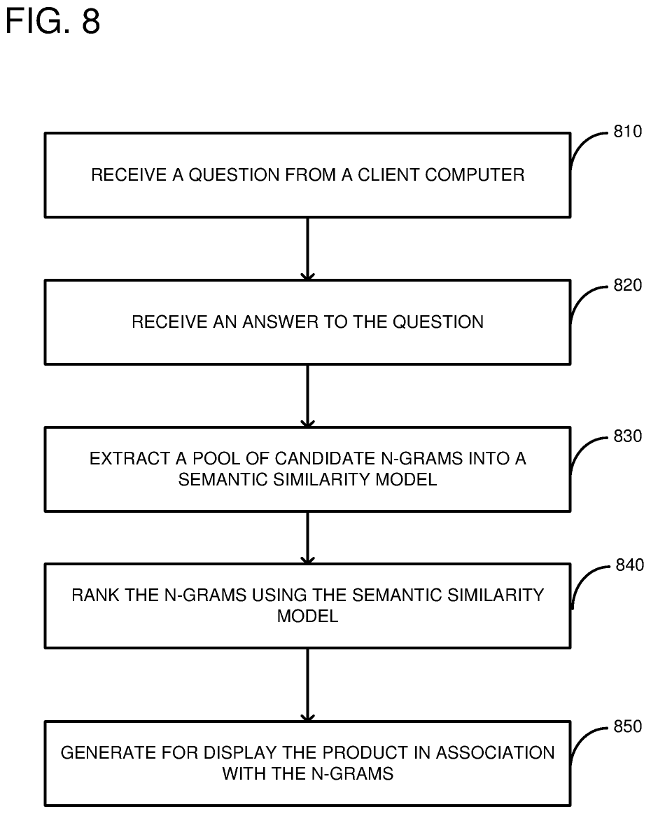

FIG. 8 is a flowchart according to one embodiment for recommending products in a UI. In process block 810, a question is received from a client computer. For example, in FIG. 1, a client computer can be associated with UI 100 and a user can enter a question into the UI, such as through an input text bar 112 (FIG. 1). Alternatively, the user can select automatically generated questions in the UI 100. In process block 820, an answer to the question can be received. For example, in FIG. 3, the answer 326 is generated by the answer generation model 320 and received by the semantic similarity model 330. In process block 830, a pool of candidate n-grams is extracted from an answer. For example, in FIG. 4, the noun phrase identifier 408 can identify noun phrases, such as are displayed at 520 in FIG. 5. In process block 840, the n-grams are ranked using the semantic similarity model. For example, in FIG. 5, the semantic similarity model can rank the noun phrases using a plurality of algorithms 540, 542, 544 and 546, which create different scores based upon combinations of questions, answers and noun phrases input into the semantic similarity model. Such scores can be used to generate a ranked output 350. Finally, in process block 850, display elements for the UI can be generated showing the product in association with the n-gram, such as is shown in FIG. 1.

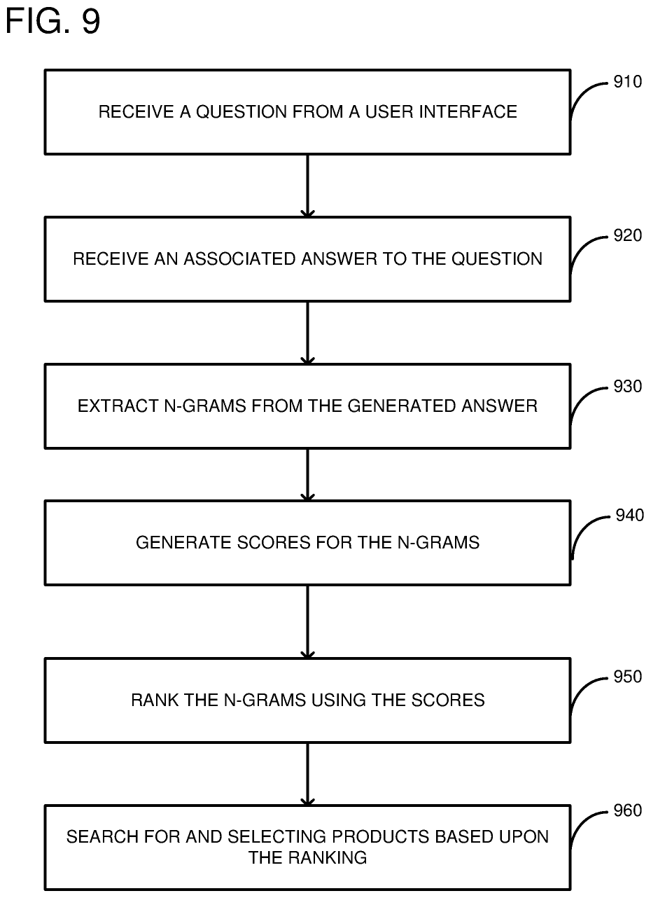

FIG. 9 is a flowchart according to another embodiment for recommending products in a UI. In process block 910, a question is received from a user interface. For example, in FIG. 3, a question 314 is entered by a user in the UI 302. The question 314 can be received by the semantic similarity model 330. In process block 920, an answer is received that is associated with the question. For example, in FIG. 3, the semantic similarity model 330 receives the answer 326 from the answer generation model 320. In process block 930, n-grams are extracted from the generated answer. For example, in FIG. 5, noun phrases are identified as indicated at 520. In process block 940, scores for the n-grams are generated. For example, in FIG. 4, the semantic similarity modules 412, 414, and 416 can generate scores 420, 422, and 424, respectively. In process block 950, the n-grams are ranked based upon the scores. For example, the ranked scores can be seen at 350. Finally, at 960, products are searched for and selected based upon the ranking. For example, in FIG. 3, the product search engine 360 can use the ranked noun phrases 350 to find product images 370 to be displayed.

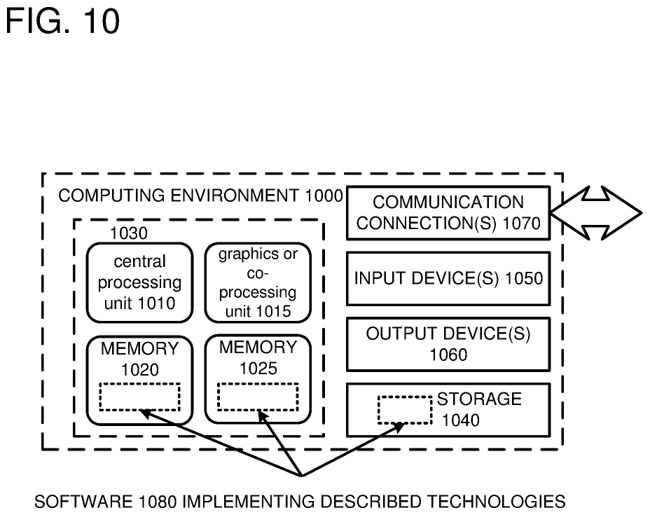

FIG. 10 depicts a generalized example of a suitable computing environment 1000 in which the described innovations may be implemented. The computing environment 1000 is not intended to suggest any limitation as to scope of use or functionality, as the innovations may be implemented in diverse general-purpose or special-purpose computing systems. For example, the computing environment 1000 can be any of a variety of computing devices (e.g., desktop computer, laptop computer, server computer, tablet computer, etc.).

With reference to FIG. 10, the computing environment 1000 includes one or more processing units 1010, 1015 and memory 1020, 1025. In FIG. 10, this basic configuration 1030 is included within a dashed line. The processing units 1010, 1015 execute computer-executable instructions. A processing unit can be a general-purpose central processing unit (CPU), processor in an application-specific integrated circuit (ASIC) or any other type of processor. In a multi-processing system, multiple processing units execute computer-executable instructions to increase processing power. For example, FIG. 10 shows a central processing unit 1010 as well as a graphics processing unit or co-processing unit 1015. The tangible memory 1020, 1025 may be volatile memory (e.g., registers, cache, RAM), non-volatile memory (e.g., ROM, EEPROM, flash memory, etc.), or some combination of the two, accessible by the processing unit(s). The memory 1020, 1025 stores software 1080 implementing one or more innovations described herein, in the form of computer-executable instructions suitable for execution by the processing unit(s). For example, the semantic similarity model can be implemented in the software 1080.

A computing system may have additional features. For example, the computing environment 1000 includes storage 1040, one or more input devices 1050, one or more output devices 1060, and one or more communication connections 1070. An interconnection mechanism (not shown) such as a bus, controller, or network interconnects the components of the computing environment 1000. Typically, operating system software (not shown) provides an operating environment for other software executing in the computing environment 1000, and coordinates activities of the components of the computing environment 1000.

The tangible storage 1040 may be removable or non-removable, and includes magnetic disks, magnetic tapes or cassettes, CD-ROMs, DVDs, or any other medium which can be used to store information in a non-transitory way and which can be accessed within the computing environment 1000. The storage 1040 stores instructions for the software 1080 implementing one or more innovations described herein.

The input device(s) 1050 may be a touch input device such as a keyboard, mouse, pen, or trackball, a voice input device, a scanning device, or another device that provides input to the computing environment 1000. The output device(s) 1060 may be a display, printer, speaker, CD-writer, or another device that provides output from the computing environment 1000.

The communication connection(s) 1070 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions stored on one or more computer-readable storage media (e.g., one or more optical media discs, volatile memory components (such as DRAM or SRAM), or non-volatile memory components (such as flash memory or hard drives)) and executed on a computer (e.g., any commercially available computer, including smart phones or other mobile devices that include computing hardware). The term computer-readable storage media does not include communication connections, such as signals and carrier waves. Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, aspects of the disclosed technology can be implemented by software written in C++, Java, Perl, any other suitable programming language. Likewise, the disclosed technology is not limited to any particular computer or type of hardware. Certain details of suitable computers and hardware are well known and need not be set forth in detail in this disclosure.

It should also be well understood that any functionality described herein can be performed, at least in part, by one or more hardware logic components, instead of software. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and subcombinations with one another. The disclosed methods, apparatus, and systems are not limited to any specific aspect or feature or combination thereof, nor do the disclosed embodiments require that any one or more specific advantages be present or problems be solved.

In view of the many possible embodiments to which the principles of the disclosed invention may be applied, it should be recognized that the illustrated embodiments are only examples of the invention and should not be taken as limiting the scope of the invention. We therefore claim as our invention all that comes within the scope of these claims.

What is claimed is:

1. A method of recommending products, the method comprising:
receiving a question from a client computer entered through an input text box in a User Interface (UI);
receiving an answer to the question;
extracting a pool of candidate noun phrases including words from the answer;
inputting the question, answer and the candidate noun phrases into a semantic similarity model;
ranking the noun phrases using the semantic similarity model;
for a highest ranked noun phrase, identifying a product for display in the UI; and
generating, for display, the product in association with the noun phrase.

2. The method of claim 1, further including training the semantic similarity model using a first search including the question and a second search including a search term, wherein both the first and second searches result in a same product found.

3. The method of claim 1, wherein the ranking includes using a plurality of different input sequences into the semantic similarity model to receive a plurality of numerical scores.

4. The method of claim 3, wherein the plurality of different input sequences includes a first of the candidate noun phrases and the question and a first of the candidate noun phrases and the answer.

5. The method of claim 1, further including training the semantic similarity model using click data received in an e-commerce website.

6. A method, comprising:
receiving a question from a user interface;
receiving an associated answer to the question;
extracting n-grams from the generated answer;
generating scores for the n-grams using at least one semantic similarity module that inputs the n-grams and one or both of the question and the answer;
ranking the n-grams using the scores; and
searching for and selecting products based upon the ranking.

7. The method of claim 6, wherein the semantic similarity modules include the following inputs:
the n-grams and the question;
the n-grams and the answer; and
the n-grams and the question and the answer.

8. The method of claim 6, further including training the plurality of semantic similarity modules using click data from product queries in an e-commerce website.

9. The method of claim 6, further including training the plurality of semantic similarity modules using a first search including a question and a second search including a search term, wherein both the first and second searches result in a same product found.

10. The method of claim 6, further including displaying the selected products on a User Interface (UI).

11. The method of claim 6, wherein the n-grams are identified using a Natural Language Processing (NLP) modeling tool and wherein the n-grams include noun phrases.

12. The method of claim 6, further including associating at least one of the n-grams with the selected products on a User Interface (UI).

13. The method of claim 6, wherein the ranking is based upon which n-grams are most likely to be associated with products.

14. The method of claim 6, further including adjusting weighting in the semantic similarity modules using pre-trained sentence Bidirectional Encoder Representations from Transformers (BERT) models.

15. One or more computer-readable media comprising computer-executable instructions that, when executed, cause a computing system to perform a method comprising:
generating an answer to a user question;
extracting noun phrases in the answer using a Natural Language Processing (NLP) model;
inputting the extracted noun phrases and the user question into a semantic similarity model to determine a product associated with the noun phrases; and
transmitting an image of the determined product for display in association with a corresponding one of the selected noun phrases.

16. The one or more computer-readable media of claim 15, wherein the method further includes inputting the extracted noun phrases and the answer into the semantic similarity model to generate a score and determining the product using the score.

17. The one or more computer-readable media of claim 15, wherein the semantic similarity model is used to generate a plurality of scores using combinations of the extracted noun phrases with combinations of the user question and the answer.

18. The one or more computer-readable media of claim 17, wherein the selected scores are used in ranking the noun phrases.

19. The one or more computer-readable media of claim 18, wherein a highest ranked noun phrase in the ranking of the noun phrases is used to search for the determined product.

20. The one or more computer-readable media of claim 15, wherein the method further includes training the plurality of semantic similarity models using click data from product queries in an e-commerce website.
